(19) United States
(12) Patent Application Publication
(10) Pub. No.: US 2009/0094975 A1
(43) Pub. Date: Apr. 16, 2009

(54) HYDRAULIC SWIVEL MOTOR AND METHOD FOR PRODUCING THE SAME

(75) Inventors: Frank HALTERMAN, Heidenau (DE); Andreas BEHNKE, Hamburg (DE)

Correspondence Address: Pepper Hamilton LLP, 400 Berwyn Park, 899 Cassatt Road, Berwyn, PA, 19312-1183, US

(73) Assignee: RAUSCH & PAUSCH GMBH, Selb (DE)

(21) Appl. No.: 12/249,292

(22) Filed: Oct. 10, 2008

(30) Foreign Application Priority Data
Oct. 12, 2007 (DE) 10 2007 049 130.3

(51) Int. Cl. F15B 9/14; F16H 47/04; F16H 61/50; B23P 19/00; B23P 11/00

(52) U.S. Cl. 60/487; 29/888.025

(57) ABSTRACT

The hydraulic chamber (2) of a hydraulic swivel motor comprises a lateral opening which is closed by means of a cover (8). The seal of the hydraulic chamber with respect to the surroundings is achieved by a circumferential cover seal (12) which is produced by friction stir welding. The weld root (12′) extends to the vicinity of the faces of a sealing strip (10) which is provided between a shaft (4) and the cover (8) for separating two working chambers (A, B). This measure prevents leakage to the surroundings, on the one hand, and minimizes leakage between the working chambers (A, B), on the other hand.

### CROSS REFERENCE TO RELATED APPLICATIONS

This application is claims priority to German Application No. 10 2007 049 130.3, filed Oct. 12, 2007, which is incorporated herein by reference in its entirety.

### TECHNOLOGY FIELD

This invention relates to a method for producing a hydraulic swivel motor and to an accordingly produced swivel motor having the features of an improved seal of the hydraulic chamber with respect to the surroundings and/or between the two working chambers achieved by a circumferential cover seal produced by friction stir welding.

### BACKGROUND

A hydraulic swivel motor is used to convert hydraulic forces into mechanical forces, namely into rotation. A hydraulic swivel motor possesses for this purpose a hydraulic chamber comprising two working chambers. Each of said working chambers has at least one hydraulic connection for supplying and removing hydraulic fluid. To the extent that hydraulic fluid is supplied to one working chamber, hydraulic fluid is displaced from the other working chamber. This is obtained by means of a shaft penetrating the hydraulic chamber and having a vane protruding radially from the shaft to divide the hydraulic chamber into the two working chambers. A circumferential seal seals the vane at the inner wall of the hydraulic chamber. Further, the working chambers are separated from each other by means of a sealing strip stationarily located in the cover and extending axially along the shaft between the shaft and an inside wall of the hydraulic chamber. When hydraulic fluid is pumped into one working chamber, the hydraulic fluid cannot flow into the other working chamber due to the sealing strip on one side of the shaft and the seal on the vane on the other side of the shaft, but instead shifts the vane in the hydraulic chamber while displacing a corresponding hydraulic fluid volume out of the other working chamber. This leads to rotation of the shaft due to the firm coupling of the vane with the shaft.

The hydraulic chamber cannot be constituted by a self-contained housing, however. Rather, there are provided at least one, normally two, openings for guiding through and mounting the shaft. Furthermore, there is provided a further, bottom-side opening of the hydraulic chamber to permit the vane to be mounted on the shaft. For it is not possible to guide the shaft including the vane through the shaft openings of the hydraulic chamber. The bottom-side opening is closed with a cover after the shaft has been inserted into the hydraulic chamber through the shaft opening, and the vane has been connected to the shaft through the lateral opening. The above-mentioned sealing strip between the shaft and the inner wall of the hydraulic chamber is then seated between the shaft and the cover.

Both the cover opening and the shaft openings are sealed against leakage by means of conventional ring seals. Due to the extremely high hydraulic pressure within the working chambers, said seals are highly loaded and leakage can occur. Said leakage can occur on the one hand to the surroundings, namely on the cover seal and on the shaft seals, and on the other hand between the two working chambers, namely between the shaft and the sealing strip extending axially thereto on the one hand and between the vane and the inner wall of the hydraulic chamber on the other hand.

Furthermore, there is a further place, more precisely two further places, where leakage occurs from one working chamber to the other working chamber, namely between the cover and the inner wall of the hydraulic chamber below the two faces of the above-mentioned sealing strip. For the faces of the sealing strips are not at the level of the circumferential cover seal, but are offset radially inward therefrom for manufacturing reasons, so that there exists between the faces of the sealing strip and the circumferential cover seal a distance which should be kept as small as possible but can nevertheless cause non-negligible leakage flows due to the high hydraulic pressures.

### SUMMARY

One object of the present invention is to prevent as effectively as possible the leakage flows between parts not moving relative to each other, that is, a leakage of the circumferential cover seal to the surroundings and a leakage from one working chamber to the other working chamber between the cover and the inner wall of the hydraulic chamber.

This object may be achieved by the circumferential cover seal being executed as a friction stir weld joint. The use of this specific welding process does not only makes it possible to produce the cover seal, that is, the seal between the cover and an inner wall of the hydraulic chamber with respect to the surroundings, so as to be absolutely tight. This would be equally possible with any other welding process. The special value of this kind of weld joint is rather that only very little thermal energy is supplied to the parts upon joining and, due to this fact, the weld seam can be formed very close to the sealing strip normally made of plastic. The distance between the circumferential weld seam seal and the faces of the sealing strip can therefore be kept very small, and it is quite conceivable for it to extend up to the sealing strip. There arises at this point in any case at least a smaller leakage cross section between the two working chambers, which increases the efficiency of the swivel motor.

Additional features and advantages of the invention will be made apparent from the following detailed description of illustrative embodiments that proceed with reference to the accompanying drawings.

### BRIEF DESCRIPTION OF THE DRAWINGS

The invention will hereinafter be explained with reference to the accompanying drawings. Therein are shown:

FIG. 1 is an exploded view of the individual parts for an inventive swivel motor;

FIG. 2 shows a section through the swivel motor transversely to the shaft, according to the prior art; and

FIG. 3 shows a section through an inventive swivel motor transversely to the shaft.

### DETAILED DESCRIPTION OF EMBODIMENTS

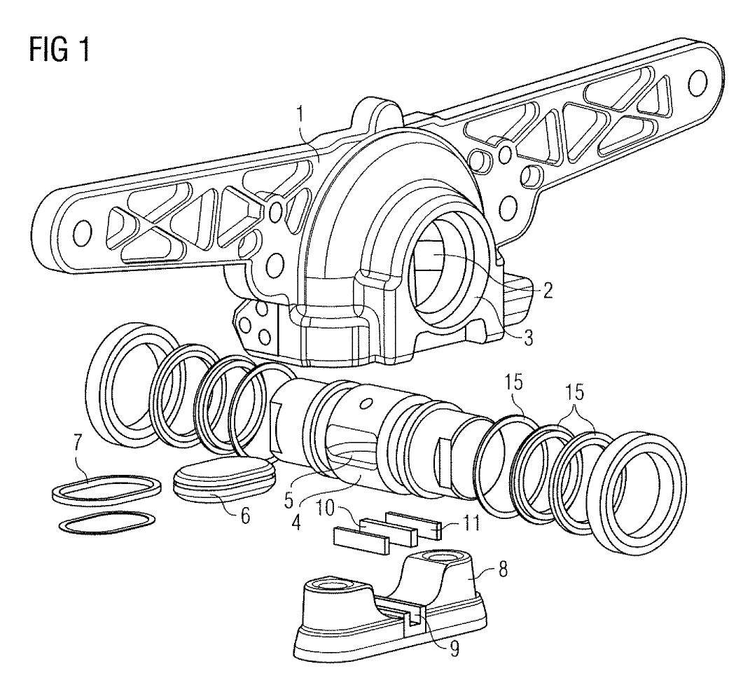

FIG. 1 shows an exploded view of the individual components of a hydraulic swivel motor as they can also be provided in connection with the inventive swivel motor. The swivel motor accordingly comprises a stator 1 which at the same time has the housing for the hydraulic chamber 2 and the openings to the hydraulic chamber including the hydraulic connections for supplying and removing hydraulic fluid (not shown). Through an opening 3 in the stator 1, which is at the same time executed as a bearing seat, a shaft 4 is insertable into the hydraulic chamber 2. A shaft seal assembly 15 seals the hydraulic chamber 2 from the surroundings on each side of the shaft 4. Into a mount 5 of the shaft 4 there is inserted a vane 6 which is provided circumferentially with a vane seal 7 to minimize leakage between the outer edge of the vane 6 and an inner wall of the hydraulic chamber 2. The vane 6 is introduced into the hydraulic chamber 2 from below and inserted into the mount 5 of the shaft 4 through an opening which cannot be seen in FIG. 1. Subsequently said lower opening is closed by means of a cover 8. The cover 8 possesses a groove 9 for receiving a bar seal 10 and two support strips 11, made for example of PTFE, which laterally support the bar seal 10 and do not have any sealing function themselves. The bar seal 10 produces a tight connection between the surface of the shaft 4 and the cover 8.

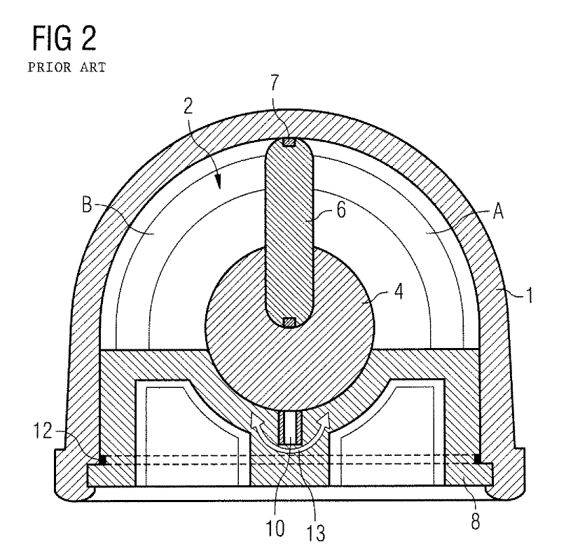

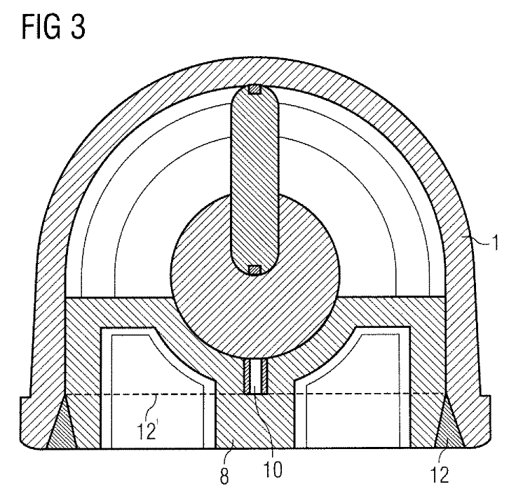

FIG. 2 shows a cross section through the swivel motor from FIG. 1 transversely to the shaft 4, first according to the prior art. It can be clearly seen how the vane 6 divides the hydraulic chamber 2 into two working chambers A and B. The cover 8 serves on both sides as a stop for the swivel motion of the vane 6. Adding to the exploded view from FIG. 1, there can be seen here circumferentially around the cover 8 a cover seal 12 with which the inside of the hydraulic chamber 2 is sealed from the surroundings in the area of the cover opening. It can be seen that between the faces of the sealing strip 10 and the cover seal 12 there exists a distance which leads to leakage flows 13 between the two working chambers A, B. This is at least reduced by the inventive formation of the cover seal 12 by friction stir welding, as will be explained hereinafter with reference to FIG. 3.

Instead of the cover seal 12 configured for example as an O-ring according to FIG. 2, the cover seal 12 in FIG. 3 is configured as a friction stir weld seam. It can be seen that the weld seam root 12′ of the circumferential friction stir weld seam extends up to the level of the sealing strip 10, so that a leakage as shown as leakage flow 13 in FIG. 2 occurs in any case only to a small extent.

For processing reasons it is expedient if the cover 8 is so disposed in the stator 1 that the outer surface of the cover 8 is flush with the stator 1 in any case at the place where it is to be connected to the stator 1 by the friction stir welding process, as shown in FIG. 3. Friction stir welding designates a welding process known since 1991 which is fundamentally known to the person skilled in the art. It is characterized by two parts to be welded together being welded together via a butt joint by a pin rotating at high speed being urged with great force into the butt joint and moved along the joint line. The pin protrudes from a cylindrical shoulder resting on the surface of the parts to be welded together. The friction between the shoulder, the pin and the workpiece causes the workpiece to heat to the point of softening. The advancing motion along the joint line stirs the plasticized material and transports it from the front side of the pin to the back side thereof. The applied pressure causes the material to be compressed and to form a metallic, tight bond upon cooling.

What is claimed is:

1. A hydraulic swivel motor, comprising:
a hydraulic chamber (2);
a shaft (4) penetrating the hydraulic chamber (2);
a vane (6) protruding radially from the shaft (4) and dividing the hydraulic chamber (2) such that on each side of the vane (6) there arises a working space (A, B) which has at least one connection for supplying and removing hydraulic fluid;
the hydraulic chamber possessing an opening closed by a cover (8), the cover (8) being sealed (12) all round to prevent leakage of hydraulic fluid through the opening; and
a sealing strip (10) extending axially along the shaft (4) being provided between the cover (8) and the shaft (4) to mutually seal the working spaces (A, B) formed by the vane (6) on the side of the shaft (4) opposite the vane (6);
wherein the circumferential cover seal (12) is executed as a friction stir weld joint.

2. The hydraulic swivel motor according to claim 1, wherein the cover (8) and a wall of the hydraulic chamber (2) are flush with each other in the total area where the cover (8) and the hydraulic chamber (2) are connected by friction stir welding.

3. The hydraulic swivel motor according to claim 2, wherein a weld root (12′) of the cover seal (12) executed as a friction stir weld joint extends up to the sealing strip (10).

4. The hydraulic swivel motor according to claim 1, wherein a weld root (12′) of the cover seal (12) executed as a friction stir weld joint extends up to the sealing strip (10).

5. A method for producing a hydraulic swivel motor, the method comprising the steps of:
providing a hydraulic chamber (2);
inserting a shaft (4) into the hydraulic chamber (2) through a first opening (3) of the hydraulic chamber (2);
inserting a vane (6) into the shaft (4) through a second opening of the hydraulic chamber (2) such that the vane (6) protrudes radially from the shaft (4) and divides the hydraulic chamber into working spaces (A, B);
inserting a cover (8) into the second opening for closing the second opening, whereby a sealing strip (10) extending axially along the shaft is provided between the cover (8) and the shaft (4) to mutually seal the working spaces (A, B) formed by the vane (6) on the side of the shaft (4) opposite the vane (6); and
sealing the cover (8) in the second opening by a circumferential cover seal (12) produced by friction stir welding.

6. The method according to claim 5, further comprising extending a weld root (12′) of the cover seal (12) produced by friction stir welding up to the sealing strip (10).
